(19) United States
(12) Patent Application Publication
(10) Pub. No.: US 2017/0280444 A1
(43) Pub. Date: Sep. 28, 2017

(54) ACCESS POINT (AP), STATION (STA) AND METHOD FOR USAGE OF A FRAME FORMAT BASED ON A PHASE NOISE MEASUREMENT

(71) Applicants: CLAUDIO DA SILVA, San Jose, CA (US); Woo Bong Lee, Pleasanton, CA (US)

(72) Inventors: CLAUDIO DA SILVA, San Jose, CA (US); Woo Bong Lee, Pleasanton, CA (US)

(21) Appl. No.: 15/080,034

(22) Filed: Mar. 24, 2016

(51) Int. Cl. H04W 72/04; H04L 27/26; H04L 5/00; H04W 72/08

(52) U.S. Cl. CPC H04W 72/0446; H04W 72/0413; H04W 72/085; H04L 27/26; H04L 5/0048

(57) ABSTRACT

Embodiments of an access point (AP), station (STA) and method for communication in accordance with frame formats of varying sizes of pilot portions are generally described herein. The AP may transmit, to the STA, a first downlink frame in accordance with a first downlink frame format. The AP may receive, from the STA, a phase noise measurement of the STA. The AP may select, based at least partly on the received phase noise measurement, a downlink frame format to enable a phase noise compensation at the STA. The AP may generate a downlink frame in accordance with the second downlink frame format, and may transmit the second downlink frame to the STA. In some cases, the first and second downlink frame formats may be based on different ratios of pilot portions to data portions.

### TECHNICAL HELD

Embodiments pertain to wireless networks. Some embodiments relate to wireless local area networks (WLANs) and networks including networks operating in accordance with the IEEE 802.11 family of standards. Some embodiments relate to millimeter wave (mmWave) communication, including mmWave communication in accordance with IEEE 802.11ad and/or IEEE 802.11ay. Some embodiments relate to mmWave communication in accordance with Fifth Generation (5G) networks. Some embodiments relate to receiver impairments, including phase noise.

### BACKGROUND

Mobile devices may communicate with a base station of a mobile network to exchange data, voice and other information. In some cases, performance of the mobile device may be affected by any number of factors, including various receiver issues and challenges. For instance, phase noise associated with operation of the mobile device may affect the ability of the mobile device to receive data from the base station, in some cases. Accordingly, there is a general need for methods and systems that address these and other scenarios.

### BRIEF DESCRIPTION OF THE DRAWINGS

FIG. 1 illustrates a wireless network in accordance with some embodiments;

FIG. 2 illustrates an example machine in accordance with some embodiments;

FIG. 3 illustrates a station (STA) in accordance with some embodiments and an access point (AP) in accordance with some embodiments;

FIG. 4 illustrates the operation of a method of communication in accordance with some embodiments;

FIG. 5 illustrates example downlink frame formats in accordance with some embodiments;

FIG. 6 illustrates the operation of another method of communication in accordance with some embodiments; and

FIG. 7 illustrates an example block diagram of receiver operations in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

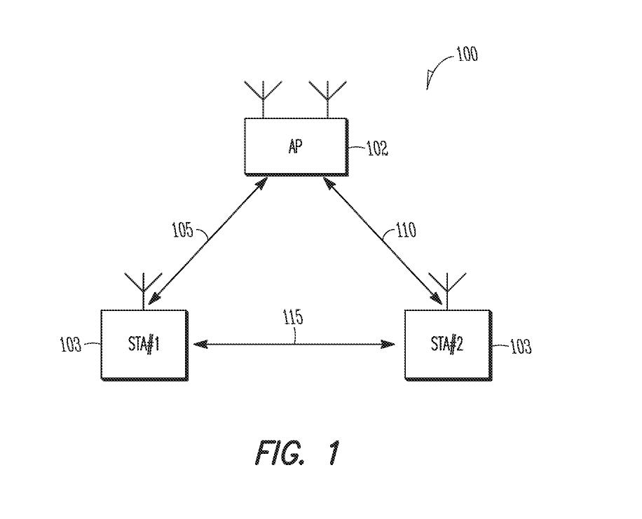

FIG. 1 illustrates a wireless network in accordance with some embodiments. In some embodiments, the network 100 may be a Wireless Local Area Network (WLAN) or a Wi-Fi network, although the scope of embodiments is not limited in this respect. It should be noted that embodiments are not limited to the number or type of components shown in the example network 100. Embodiments are also not limited by the example network 100 in terms of the arrangement of the components or the connectivity between components as shown. In addition, some embodiments may include additional components.

The example network 100 may include one or more access points (APs) 102 and one or more stations (STAs) 103. In some embodiments, the AP 102 may be arranged to operate in accordance with one or more IEEE 802.11 standards. These embodiments are not limiting, however, as other base station components, which may or may not be arranged to operate in accordance with a standard, may be used in some embodiments. As an example, an Evolved Node-B (eNB) arranged to operate in accordance with one or more Third Generation Partnership Project (3GPP) standards, including but not limited to 3GPP Long Term Evolution (LTE) standards, may be used in some cases. In some embodiments, the STAs 103 may be arranged to operate in accordance with one or more IEEE 802.11 standards. These embodiments are not limiting, however, as other mobile devices, portable devices and/or other devices, which may or may not be arranged to operate in accordance with a standard, may be used in some embodiments. As an example, a User Equipment (UE) arranged to operate in accordance with one or more Third Generation Partnership Project (3GPP) standards, including but not limited to 3GPP LTE standards, may be used in some cases.

In some embodiments, the STAs 103 may be configured to communicate with the AP 102 and/or with other STAs 103. As shown in the example network 100 in FIG. 1, STA #1 may communicate with the AP 102 over the wireless link 105 and STA #2 may communicate with the AP 102 over the wireless link 110. In some embodiments, direct communication between STAs 103 may be possible, such as over the wireless link 115 between STA #1 and STA #2. These embodiments are not limiting, however, as the direction communication between STAs 103 may not necessarily be possible in some embodiments.

In some embodiments, the communication between the AP 102 and the STAs 103 and/or the communication between the STAs 103 may be performed in accordance with one or more standards, such as an 802.11 standard (including legacy 802.11 standards), a 3GPP standard (Including 3GPP LTE standards) and/or other standards. These embodiments are not limiting, however, as other communication techniques and/or protocols, which may or may be included in a standard, may be used for the communication between the AP 102 and the STAs 103 and/or the communication between the STAs 103, in some embodiments.

In accordance with some embodiments, the AP 102 may transmit one or more downlink frames to the STA 103 in accordance with a downlink frame format. The STA 103 may transmit, to the AP 102, a phase noise measurement for the STA 103. These embodiments will be described in more detail below.

It should be noted that the STAs 103, the AP 102, mobile devices, base stations and/or other devices may be configured to operate in various frequency bands, including but not limited to millimeter wave (mmWave), ultra high frequency (UHF), microwave and/or other frequency bands. In some cases, phase noise levels of receiver components, such as oscillators and PLLs and/or others, may affect receiver performance. Such phase noise levels may be significantly higher, in some cases, for operation in mmWave frequency bands in comparison to operation in other frequency bands. For instance, traditional wireless systems may operate in the UHF and microwave frequency bands, in some cases. Accordingly, techniques and/or operations that address receiver phase noise may be more challenging for systems operating in the mmWave frequency bands.

In some embodiments, the STAs 103, AP 102, other mobile devices, other base stations and/or other devices may be configured to perform operations related to contention based communication. As an example, the communication between the STAs 103 and/or AP 102 and/or the communication between the STAs 103 may be performed in accordance with contention based techniques. In such cases, the STAs 103 and/or AP 102 may be arranged to contend for a wireless medium (e.g., during a contention period) to receive exclusive control of the medium for a transmission period. For instance, the transmission period may include a transmission opportunity (TXOP), which may be included in an 802.11 standard and/or other standard.

It should be noted that embodiments are not limited to usage of contention based techniques, however, as some communication (such as that between mobile devices and/or communication between a mobile device and a base station) may be performed in accordance with schedule based techniques. Some embodiments may include a combination of contention based techniques and schedule based techniques.

In some embodiments, the communication between mobile devices and/or between a mobile device and a base station may be performed in accordance with any suitable multiple-access techniques and/or multiplexing techniques. Accordingly, one or more of orthogonal frequency division multiple access (OFDMA), orthogonal frequency division multiplexing (OFDM), code-division multiple access (CDMA), time-division multiple access (TDMA), frequency division multiplexing (FDMA), space-division multiple access (SDMA), multiple-input multiple-output (MIMO), multi-user (MU) multiple-input multiple-output (MIMO) (MU-MIMO) and/or other techniques may be employed in some embodiments.

In some embodiments, channels used for communication between STAs 103 and/or APs 102 may be configurable to use one of 20 MHz, 40 MHz, or 80 MHz contiguous bandwidths or an 80+80 MHz (160 MHz) non-contiguous bandwidth. In some embodiments, a 320 MHz channel width may be used. In some embodiments, subchannel bandwidths less than 20 MHz may also be used. In these embodiments, each channel or subchannel may be configured for transmitting a number of spatial streams, in some embodiments. These embodiments are not limiting, however, as other suitable bandwidths may be used in some embodiments.

In some embodiments, high-efficiency wireless (HEW) techniques may be used, although the scope of embodiments is not limited in this respect. As an example, techniques included in 802.11ax standards and/or other standards may be used. In such embodiments, an HEW packet may be generated in accordance with a short preamble format or a long preamble format. The HEW packet may comprise a legacy signal field (L-SIG) followed by one or more high-efficiency (HE) signal fields (HE-SIG) and an HE long-training field (HE-LTF). For the short preamble format, the fields may be configured for shorter-delay spread channels. For the long preamble format, the fields may be configured for longer-delay spread channels. It should be noted that the terms “HEW” and “HE” may be used interchangeably and both terms may refer to high-efficiency Wireless Local Area Network operation and/or high-efficiency Wi-Fi operation.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware. Embodiments described herein may be implemented into a system using any suitably configured hardware and/or software.

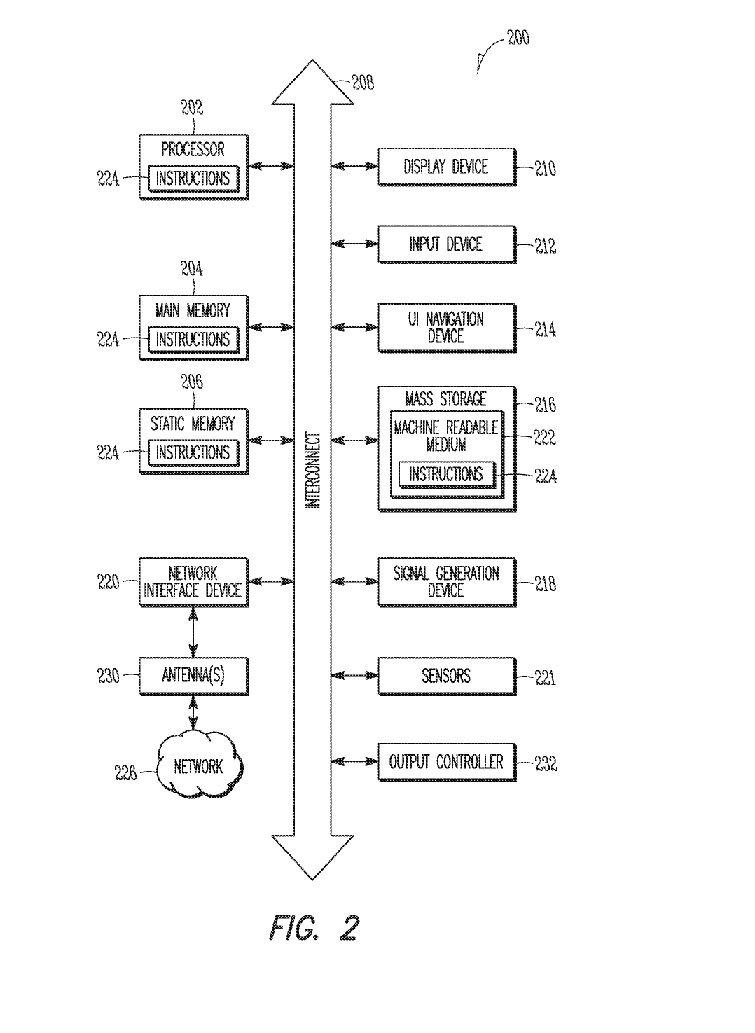

FIG. 2 illustrates a block diagram of an example machine in accordance with some embodiments. The machine 200 is an example machine upon which any one or more of the techniques and/or methodologies discussed herein may be performed. In alternative embodiments, the machine 200 may operate as a standalone device or may be connected (e.g., networked) to other machines. In a networked deployment, the machine 200 may operate in the capacity of a server machine, a client machine, or both in server-client network environments. In an example, the machine 200 may act as a peer machine in peer-to-peer (P2P) (or other distributed) network environment. The machine 200 may be an AP 102, STA 103, UE, eNB, mobile device, base station, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The machine (e.g., computer system) 200 may include a hardware processor 202 (e.g., a central processing unit (CPU), a graphics processing unit (GPU), a hardware processor core, or any combination thereof), a main memory 204 and a static memory 206, some or all of which may communicate with each other via an interlink (e.g., bus) 208. The machine 200 may further include a display unit 210, an alphanumeric input device 212 (e.g., a keyboard), and a user interface (UI) navigation device 214 (e.g., a mouse). In an example, the display unit 210, input device 212 and UI navigation device 214 may be a touch screen display. The machine 200 may additionally include a storage device (e.g., drive unit) 216, a signal generation device 218 (e.g., a speaker), a network interface device 220, and one or more sensors 221, such as a global positioning system (GPS) sensor, compass, accelerometer, or other sensor. The machine 200 may include an output controller 228, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.

The storage device 216 may include a machine readable medium 222 on which is stored one or more sets of data structures or instructions 224 (e.g., software) embodying or utilized by any one or more of the techniques or functions described herein. The instructions 224 may also reside, completely or at least partially, within the main memory 204, within static memory 206, or within the hardware processor 202 during execution thereof by the machine 200. In an example, one or any combination of the hardware processor 202, the main memory 204, the static memory 206, or the storage device 216 may constitute machine readable media. In some embodiments, the machine readable medium may be or may include a non-transitory computer-readable storage medium.

While the machine readable medium 222 is illustrated as a single medium, the term “machine readable medium” may include a single medium or multiple media (e.g., a centralized or distributed database, and/or associated caches and servers) configured to store the one or more instructions 224. The term “machine readable medium” may include any medium that is capable of storing, encoding, or carrying instructions for execution by the machine 200 and that cause the machine 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 224 may further be transmitted or received over a communications network 226 using a transmission medium via the network interface device 220 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 220 may include one or more physical jacks (e.g., Ethernet, coaxial, or phone jacks) or one or more antennas to connect to the communications network 226. In an example, the network interface device 220 may include a plurality of antennas to wirelessly communicate using at least one of single-input multiple-output (SIMO), multiple-input multiple-output (MIMO), or multiple-input single-output (MISO) techniques. In some examples, the network interface device 220 may wirelessly communicate using Multiple User MIMO techniques. The term “transmission medium” shall be taken to include any intangible medium that is capable of staring, encoding or carrying instructions for execution by the machine 200, and includes digital or analog communications signals or other intangible medium to facilitate communication of such software.

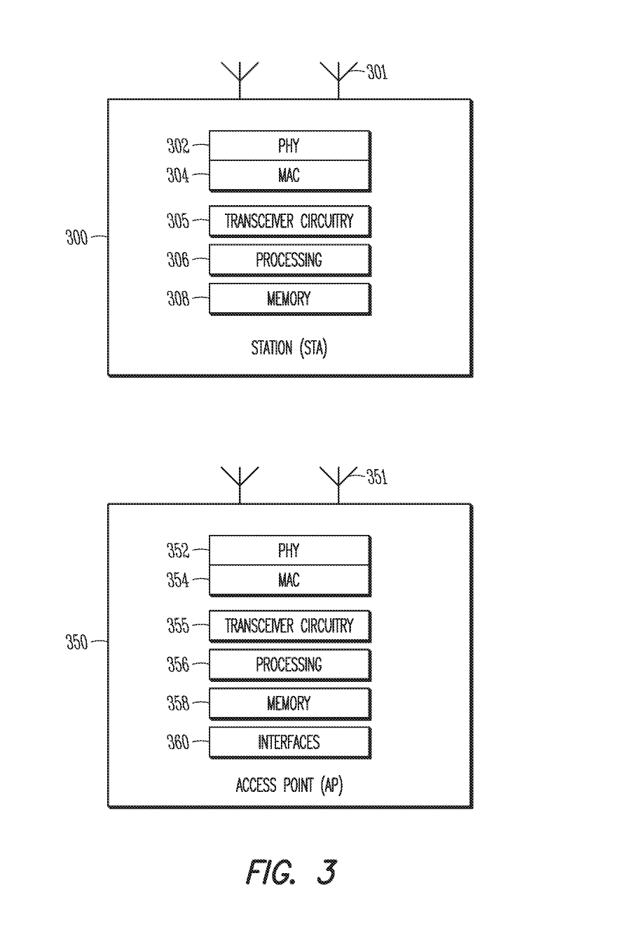

FIG. 3 illustrates a station (STA) in accordance with some embodiments and an access point (AP) in accordance with some embodiments. It should be noted that in some embodiments, an STA or other mobile device may include sonic or all of the components shown in either FIG. 2 or FIG. 3 (as in 300) or both. The STA 300 may be suitable for use as an STA 103 as depicted in FIG. 1, in some embodiments. It should also be noted that in some embodiments, an AP or other base station may include some or all of the components shown in either FIG. 2 or FIG. 3 (as in 350) or both. The AP 350 may be suitable for use as an AP 102 as depicted in FIG. 1, in some embodiments.

The STA 300 may include physical layer circuitry 302 and a transceiver 305, one or both of which may enable transmission and reception of signals to and from components such as the AP 102 (FIG. 1), other STAs or other devices using one or more antennas 301. As an example, the physical layer circuitry 302 may perform various encoding and decoding functions that may include formation of baseband signals for transmission and decoding of received signals. As another example, the transceiver 305 may perform various transmission and reception functions such as conversion of signals between a baseband range and a Radio Frequency (RF) range. Accordingly, the physical layer circuitry 302 and the transceiver 305 may be separate components or may be part of a combined component. In addition, some of the described functionality related to transmission and reception of signals may be performed by a combination that may include one, any or all of the physical layer circuitry 302, the transceiver 305, and other components or layers. The STA 300 may also include medium access control layer (MAC) circuitry 304 for controlling access to the wireless medium. The STA 300 may also include processing circuitry 306 and memory 308 arranged to perform the operations described herein.

The AP 350 may include physical layer circuitry 352 and a transceiver 355, one or both of which may enable transmission and reception of signals to and from components such as the STA 103 (FIG. 1), other APs or other devices using one or more antennas 351. As an example, the physical layer circuitry 352 may perform various encoding and decoding functions that may include formation of baseband signals for transmission and decoding of received signals. As another example, the transceiver 355 may perform various transmission and reception functions such as conversion of signals between a baseband range and a Radio Frequency (RF) range. Accordingly, the physical layer circuitry 352 and the transceiver 355 may be separate components or may be part of a combined component. In addition, some of the described functionality related to transmission and reception of signals may be performed by a combination that may include one, any or all of the physical layer circuitry 352, the transceiver 355, and other components or layers. The AP 350 may also include medium access control layer (MAC) circuitry 354 for controlling access to the wireless medium. The AP 350 may also include processing circuitry 356 and memory 358 arranged to perform the operations described herein.

The antennas 301, 351, 230 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 301, 351, 230 may be effectively separated to take advantage of spatial diversity and the different channel characteristics that may result.

In some embodiments, the STA 300 and/or AP 350 may be a mobile device and may be a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a wearable device such as a medical device (e.g., a heart rate monitor, a blood pressure monitor, etc.), or other device that may receive and/or transmit information wirelessly. In some embodiments, the STA 300 and/or AP 350 may be configured to operate in accordance with 802.11 standards, although the scope of the embodiments is not limited in this respect. Mobile devices or other devices in some embodiments may be configured to operate according to other protocols or standards, including other IEEE standards, Third Generation Partnership Project (3GPP) standards or other standards. In some embodiments, the STA 300 and/or AP 350 may include one or more of a keyboard, a display, a non-volatile memory port, multiple antennas, a graphics processor, an application processor, speakers, and other mobile device elements. The display may be an LCD screen including a touch screen.

Although the STA 300 and the AP 350 are each illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

It should be noted that in some embodiments, an apparatus used by the STA 300 may include various components of the STA 300 as shown in FIG. 3 and/or the example machine 200 as shown in FIG. 2. Accordingly, techniques and operations described herein that refer to the STA 300 (or 103) may be applicable to an apparatus for an STA, in some embodiments. It should also be noted that in some embodiments, an apparatus used by the AP 350 may include various components of the AP 350 as shown in FIG. 3 and/or the example machine 200 as shown in FIG. 2. Accordingly, techniques and operations described herein that refer to the AP 350 (or 102) may be applicable to an apparatus for an AP, in some embodiments. In addition, an apparatus for a mobile device and/or base station may include one or more components shown in FIGS. 2-3, in some embodiments. Accordingly, techniques and operations described herein that refer to a mobile device and/or base station may be applicable to an apparatus for a mobile device and/or base station, in some embodiments.

In some embodiments, the STA 300, AP 350, mobile device and/or base station may communicate using OFDM communication signals over a multicarrier communication channel. Accordingly, in some cases the STA 300, AP 350, mobile device and/or base station may be configured to receive signals in accordance with specific communication standards, such as the Institute of Electrical and Electronics Engineers (IEEE) standards including IEEE 802.11-2012, 802.11n-2009 and/or 802.11a.c-2013 standards and/or proposed specifications for WLANs including proposed HEW standards, although the scope of the embodiments is not limited in this respect as they may also be suitable to transmit and/or receive communications in accordance with other techniques and standards. In some other embodiments, the STA 300, AP 350, mobile device and/or base station may be configured to receive signals that were transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, frequency-division multiplexing (FDM) modulation and/or single carrier frequency-division multiplexing (SC-FDM) although the scope of the embodiments is not limited in this respect.

In accordance with some embodiments, the AP 102 may transmit, to the STA 103, a first downlink frame in accordance with a first downlink frame format. The AP 102 may receive, from the STA 103, a phase noise measurement of the STA 103. The AP 102 may select, based at least partly on the received phase noise measurement, a downlink frame format to enable a phase noise compensation and/or phase noise tracking at the STA 103. The AP 102 may generate a downlink frame in accordance with the second downlink frame format, and may transmit the second downlink frame to the STA 103. In some cases, the first and second downlink frame formats may be based on different ratios of pilot portions to data portions. These embodiments will be described in more detail below.

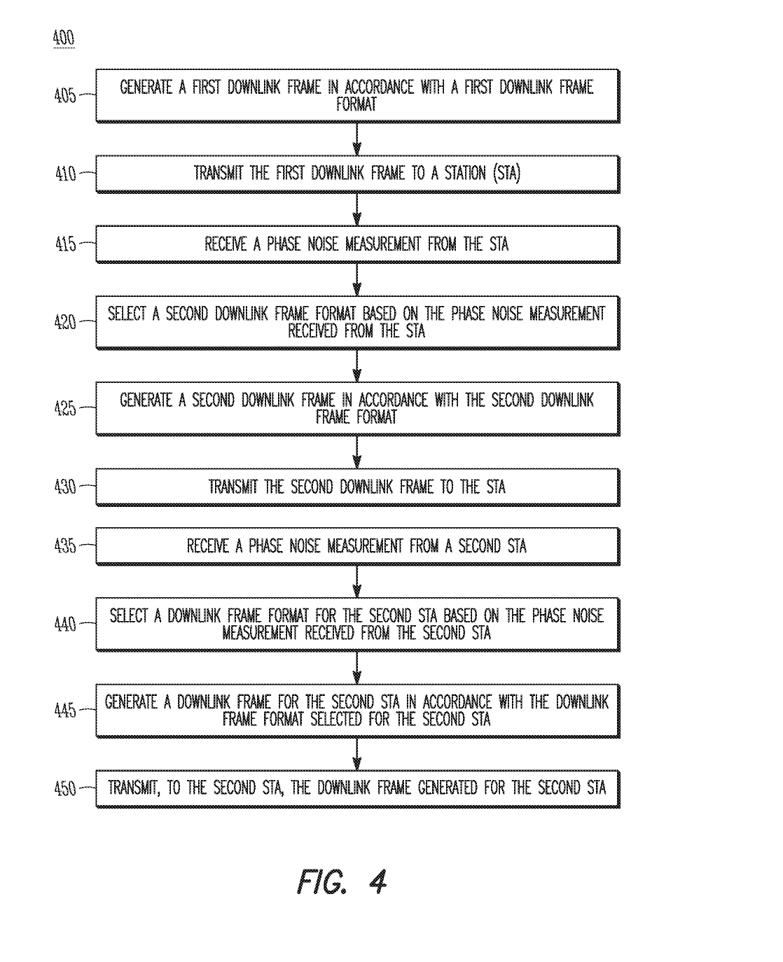

FIG. 4 illustrates the operation of a method of communication in accordance with some embodiments. It is important to note that embodiments of the method 400 may include additional or even fewer operations or processes in comparison to what is illustrated in FIG. 4. In addition, embodiments of the method 400 are not necessarily limited to the chronological order that is shown in FIG. 4. In describing the method 400, reference may be made to FIGS. 1-3 and 5-7, although it is understood that the method 400 may be practiced with any other suitable systems, interfaces and components.

In addition, the method 400 and other methods described herein may refer to STAs 103 and/or APs 102 operating in accordance with one or more standards and/or protocols, such as 802.11, Wi-Fi, wireless local area network (W-LAN) and/or other, but embodiments of those methods are not limited to just those devices. In some embodiments, the method 400 and other methods described herein may be practiced by other mobile devices, such as an HEW STA, an HEW AP, an Evolved Node-B (eNB) or User Equipment (UE). The method 400 and other methods described herein may also be practiced by wireless devices configured to operate in other suitable types of wireless communication systems, including systems configured to operate according to various Third Generation Partnership Project (3GPP) Long Term Evolution (LTE) standards. The method 400 may also be applicable to an apparatus for an STA 103 and/or AP 102 or other device described above, in some embodiments.

In some embodiments, communication between the STA 103 and an AP 102 may be performed in millimeter wave (mmWave) frequency bands. These embodiments are not limiting, however, as other frequency bands, including but not limited to ultra-high frequency (UHF) and/or microwave frequency bands, may be used in some embodiments.

At operation 405 of the method 400, the AP 102 may generate a first downlink frame in accordance with a first downlink frame format. In some embodiments, the first downlink frame may be generated for transmission to the STA 103. The AP 102 may transmit the first downlink frame to the STA 103 at operation 410. Some techniques that may be used for selection of a downlink frame format for usage, generation of a downlink frame according to a downlink frame format, transmission of downlink frames and/or other operations will be described below. It should also be pointed out that in some cases, the first downlink frame format may be based on a default format, such as an initial format used by default when the STA 103 first begins to communicate with the AP 102 or moves to a new AP 102.

At operation 415, the AP 102 may receive, from the STA 103, a phase noise measurement of the STA 103. In some embodiments, the AP 102 may determine the phase noise measurement based on a message received from the STA 103, such as a message that includes the phase noise measurement. In some embodiments, the phase noise measurement may be based on a measurement, taken at the STA 103, which may be related to phase noise generated by one or more components of the STA 103 and/or combination of such components. As non-limiting examples, phase noise may be generated at the STA by an oscillator for up-conversion of signals, an oscillator for down-conversion of signals, a component or group of components that generate clock signals and/or sinusoidal signals, a receiver block, a transmitter block and/or other component or group of components.

The phase noise measurement may be determined and/or communicated to the AP 102 using any suitable techniques. In some embodiments, the phase noise of an oscillator operating at a particular oscillator frequency may be measured and communicated to the AP 102. Power levels output by the oscillator may be measured (such as in a 1.0 Hz bandwidth or other) at the oscillator frequency and at an offset from the oscillator frequency. For instance, an average output power level in a bandwidth of 1.0 Hz at an offset frequency of 1.0 MHz may be compared to an average output power level in a bandwidth of 1.0 Hz at the oscillator frequency. As an example, the measurement may be given in terms of a number of dBc/Hz. As another example, the measurement may also be quantized into two or more ranges of dBc/Hz. As another example, the measurement may also be given in terms of a number of categories, such as high, moderate, and low. Such a categorization and/or a mapping between ranges and categories may be understood by both the STA 103 and the AP 102. As another example, an absolute power measurement of the phase noise, such as average, peak and/or other, may be determined. It should be noted that, as previously described, embodiments are not limited to determination and/or communication of phase noise of an oscillator. In some embodiments, phase noise of other components or other groups of components may be determined and/or communicated using similar techniques.

At operation 420, the AP 102 may select a second downlink frame format. The AP 102 may generate a second downlink frame in accordance with the second downlink frame format at operation 425. In some embodiments, the second downlink frame may be generated for transmission to the STA 103. At operation 430, the AP 102 may transmit the second downlink frame to the STA 103.

In some embodiments, the downlink frame may include an SC-FDM signal, in which case data portions and pilot portions of the candidate downlink frame formats may be multiplexed in time resources of the candidate downlink frame formats. As an example, a pilot portion may be followed in time by a data portion. As another example, multiple pilot portions may be interleaved in time with multiple data portions. In some embodiments, the downlink frame may include an OFDM signal, in which case data portions and pilot portions of the candidate downlink frame formats may be multiplexed in frequency resources of the candidate downlink frame formats. It should be noted that embodiments are not limited to usage of SC-FDM signals or OFDM signals.

In some embodiments, the AP 102 may select a downlink frame format (such as the first, second and/or other) based at least partly on the phase noise measurement received from the STA 103. For instance, based on a comparison of the phase noise measurement to a threshold and/or target level, the AP 102 may select the downlink frame format based on one or more factors such as a number of pilot symbols in the format, a density of pilot symbols in the format, a ratio of pilot symbols to data symbols in the format and/or other factors. In some embodiments, the pilot symbols may generally be known and/or determinable by both the AP 102 and the STA 103, and may be used for operations such as phase noise compensation, phase noise tracking, channel estimation, detection and/or others.

In some embodiments, the selection of the downlink frame format based on the comparison of the phase noise measurement may be performed to enable a trade-off between phase noise compensation/tracking capability of the STA 103 and over the air throughput. As an example, it may be determined that the phase noise measurement at the STA 103 is too high, and the usage of a downlink frame format with a relatively high number of pilot symbols, density of pilot symbols and/or ratio of pilot symbols to data symbols may enable the STA 103 to improve a phase noise compensation algorithm and/or a phase noise tracking algorithm. It should be noted that in some cases, usage of such a format may result in a reduced throughput in comparison to another downlink frame format with a lower overhead.

As another example, it may be determined that the phase noise measurement at the STA 103 is sufficiently low. Accordingly, it may be possible to use a downlink frame format with a relatively low number of pilot symbols, density of pilot symbols and/or ratio of pilot symbols to data symbols. Usage of such a format may result in an increased throughput in comparison to another downlink frame format with a higher overhead.

As another example, the first downlink frame may be transmitted prior to the second downlink frame. In some cases, it may be determined, based at least partly on the phase noise measurement, that the first downlink frame format does not have enough pilots. For instance, the phase noise measurement may be too high and/or above a threshold. Accordingly, the second downlink frame format may be selected to increase the number of pilots and to enable the STA 103 to improve a phase noise compensation performance and/or a phase noise tracking performance. In some other cases, it may be determined, based at least partly on the phase noise measurement, that the first downlink frame format has more pilots than necessary. For instance, it may be determined that the phase noise has little or no impact on performance and that the number of pilots used in the first downlink frame is more than necessary for sufficient performance. Accordingly, the second downlink frame format may be selected to decrease the number of pilots and to increase throughput on the downlink. It should be noted that in some other cases, it may be determined that no change in formats is necessary and/or that it is appropriate to continue usage of the first downlink frame format. That is, the second and first downlink frame formats may be the same in such cases.

As another example, the AP 102 may transmit one or more downlink frames to the STA 103 in accordance with the first downlink frame format. That is, the first downlink frame format may be a current format used by the AP 102 during a first time period. At some point, the AP 102 may determine that the phase noise measurement is too high or too low (such as in comparison to a threshold) and may select the second downlink frame format (with a higher or lower density of pilot symbols, respectively) for usage as an updated format to be used by the AP 102 during a subsequent second time period. Accordingly, the AP 102 may transmit one or more downlink frames to the STA 103 in accordance with the second downlink frame format during the second time period. In addition, the AP 102 may select a third downlink frame format, in some cases, based at least partly on a second phase noise measurement. For instance, the phase noise level at the STA 103 may change to a second phase noise level and it may be determined that the third format is more appropriate for the second phase noise level. In some cases, the AP 102 may revert back to usage of the first downlink frame format.

In some embodiments, these operations may be extended to include subsequent phase noise measurements and possibly subsequent changing of the downlink frame format to be used. Accordingly, an ongoing process may be performed of maintaining an appropriate downlink frame format based on a phase noise measurement at the STA 103 that may change over time. However, it should be noted that in some cases, such changes may be gradual, such as changes that are based on age and/or temperature. Accordingly, the AP 102 may not necessarily need continuous updates of the phase noise measurement in these cases, and may receive such measurements at an infrequent rate (which may or may not be on a regular basis). However, embodiments are not limited as such, and the STA 103 may send phase noise measurements on a regular basis that may be frequent in some cases.

In some embodiments, the downlink frame format may be selected from a group of candidate downlink frame formats, although the scope of embodiments is not limited in this respect. The group of candidate downlink frame formats may include any suitable number of formats, and is not limited to the two formats described in the previous examples. As an example, the group of candidate downlink frame formats may be based on data portions and pilot portions, and sizes of the pilot portions of at least some of the candidate downlink frame formats may be different. That is, downlink frames transmitted according to different candidate downlink frame formats may include a different number of pilot symbols, density of pilot symbols and/or ratio of pilot symbols to data symbols.

In some embodiments, the selection of the downlink frame format may be based on a mapping between the candidate downlink frame formats and phase noise ranges for the received phase noise measurement. For instance, a first format with a highest number and/or density of pilots may be used when the phase noise measurement is relatively high and a second format with a lowest number and/or density of pilots may be used when the phase noise measurement is relatively low. As an example, the mapping may be based at least partly on a non-decreasing relationship between the phase noise ranges and the sizes of the pilot portions of the candidate downlink frame formats. As another example, the mapping may be based at least partly on a non-decreasing relationship between the phase noise ranges and the densities of the pilot portions of the candidate downlink frame formats. As another example, the mapping may be based at least partly on a non-decreasing relationship between the phase noise ranges and the ratios between pilot portion size and data portion size for the candidate downlink frame formats.

It should also be noted that embodiments are not limited to usage of ranges or mappings. As an example, the phase noise measurement value may be an input to a function that determines which candidate downlink frame format is to be used. As another example, such a function may be based on the phase noise ranges previously described and/or other factors.

It should also be noted that embodiments are not limited to usage of phase noise measurements and/or ranges of such measurements. As an example, when the STA 103 may indicate either a “high” or “low” level of phase noise and the AP 102 may select a downlink frame format with a highest density or lowest density of pilot symbols based on the high/low indication from the STA 103.

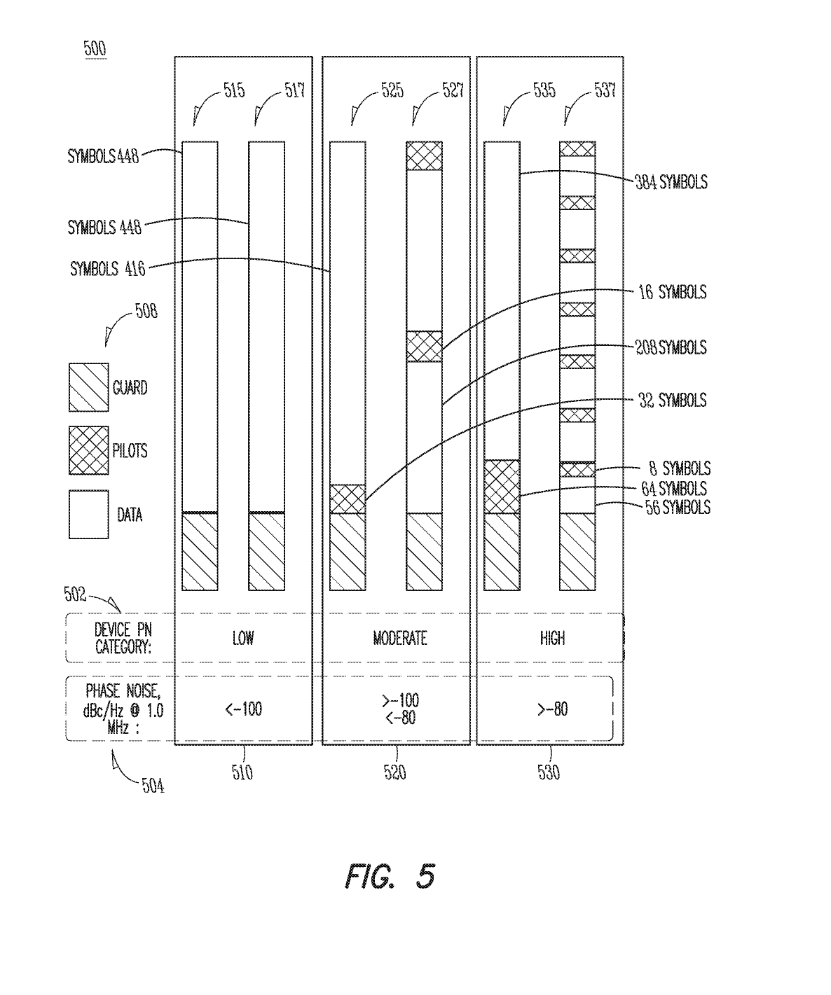

FIG. 5 illustrates example downlink frame formats in accordance with some embodiments. It should be noted that the example formats shown in FIG. 5 may serve to illustrate some or all of the concepts and techniques described herein, but embodiments are not limited by the example formats. For instance, embodiments are not limited by the number, type, arrangement and/or other aspects of the example downlink frame formats 515, 517, 525, 527, 535, 537 shown in FIG. 5. Embodiments are also not limited to the examples of ranges and/or classifications 502 and 504 shown in FIG. 5. In addition, embodiments are also not limited to the number of pilot symbols, number of data symbols and/or ratios of pilot symbols to data symbols as shown in FIG. 5.

In addition, the downlink frame formats shown in FIG. 5 may multiplex data symbols and pilot symbols in time resources, but embodiments are not limited to multiplexing in time, as frequency multiplexing (such as in OFDM) may be used in some embodiments. In some embodiments, SC-FDM may be used in the example downlink frame formats shown in FIG. 5, although embodiments are not limited as such. One or more of the example downlink frame formats shown in FIG. 5 may be included in a standard (such as IEEE 802.11ad, IEEE 802.11ay and/or other) in some cases, but embodiments are not limited to usage of formats that are included in a standard.

Referring to FIG. 5, a phase noise measurement may be used by AP 102 to determine a downlink frame format. As an example, a phase noise category 502 may take values of low, moderate (medium), and high. For the low category 510, one of the downlink frame formats 515, 517 may be used. For the moderate category 520, one of the downlink frame formats 525, 527 may be used. For the high category 530, one of the downlink frame formats 535, 537 may be used. It should be noted that a phase noise range 504 in dBc/Hz (at an offset of 1.0 MHz from an oscillator frequency) may also be used in some embodiments. It should be noted that embodiments are not limited to the example ranges of dBc/Hz shown in FIG. 5. As previously described, the category 502 and/or phase noise range 504 may be communicated by the STA 103 in some cases, and may be determined (at least partly) by the AP 102 in some cases. For instance, the STA 103 may send a value in dBc/Hz and the AP 102 may categorize the value into low, moderate or high, in some cases.

It should be noted that as shown in the legend 508, a guard period (indicated by a dashed pattern) may be used at the beginning of the downlink frame format. For the low category 510, each of the example formats 515, 517 includes a data portion of 448 symbols. It should be noted that pilot symbols are excluded from formats 515, 517.

For the moderate category 520, format 525 includes a pilot portion of 32 symbols followed by a data portion of 416 symbols, while format 527 includes two pilot portions of 16 symbols interleaved with two data portions of 208 symbols. Accordingly, formats 525 and 527 include 32 pilot symbols.

For the high category 530, format 535 includes a pilot portion of 64 symbols followed by a data portion of 384 symbols, while format 537 includes seven pilot portions of 8 symbols interleaved with seven data portions of 56 symbols. Accordingly, format 535 includes 64 pilot symbols while format 537 includes 56 symbols. It should be noted that more pilot symbols are used for the high category 530 in comparison to the moderate category 520 and low category 510. In addition, more pilot symbols are used for the moderate category 520 in comparison to the low category 510.

It should also be noted that formats 515, 525, and 535 are of the format of a pilot portion followed by a data portion. Formats 517, 527, and 537 are of a format that includes pilot portions interleaved with data portions.

As a non-limiting example, formats 515, 525, and 535 may be used as a group of candidate downlink frame formats from which the AP 102 may select a downlink frame format. As another non-limiting example, formats 517, 527, and 537 may be used as a group of candidate downlink frame formats from which the AP 102 may select a downlink frame format. Embodiments are not limited to these example groups or to these downlink frame formats, however. In some embodiments, the group of candidate downlink frame formats may include one or more of the formats shown and may even include additional formats in some cases. In some embodiments, the group of candidate downlink frame formats may not necessarily include any of the formats shown, but may include similar formats and/or other formats.

In addition, for each format shown in FIG. 5, a combined size of pilot symbols and data symbols is the same (448 in the example). In some embodiments, a number of available symbols (such as payload symbols) may be divided between data symbols and pilot symbols. Accordingly, two different formats may differ in terms of ratio of pilot symbols to data symbols, number of pilot symbols and/or density of pilot symbols.

At operation 435, the AP 102 may receive a phase noise measurement from a second. STA 103 and may select a downlink frame format for the second STA 103 based on the phase noise measurement received from the second STA 103 at operation 440. At operation 445, the AP 102 may generate one or more downlink frames for the second STA 103 in accordance with the downlink frame format selected for the second STA 103. At operation 450, the AP 102 may transmit the one or more downlink frames to the second STA 103.

In some embodiments, the AP 102 may communicate with multiple STAs 103. Accordingly, different downlink frame formats may be used for different STAs 103, in some cases, such as when phase noise levels the STAs 103 are different. For instance, the AP 102 may use operations like those previously described to determine a downlink frame format for each STA 103.

As an example, one or more operations (including but not limited to those described earlier) may be performed as part of determining appropriate downlink frame formats for the first STA 103 during a first time period based on one or more phase noise measurements received from the first STA 103 throughout the first time period. During a second overlapping time period, similar operations may be performed as part of determining appropriate downlink frame formats for the second STA 103 during the second time period based on one or more phase noise measurements received from the second STA 103 throughout the second time period.

In some cases, the AP 102 may use downlink frame formats for the first STA 103 and the second STA 103 that may be different. Accordingly, a current downlink frame format used for the first STA 103 may be different from a current downlink frame format used for the second. STA 103, in some cases. Such a difference may occur, for instance, when phase noise levels of the first STA 103 and second STA 103 are different. In some embodiments, techniques and/or operations such as those described previously for the case of the AP 102 communicating with the two STAs 103 (first and second) may be extended to cases in which the AP 102 communicates with any suitable number of STAs 103 during overlapping time periods.

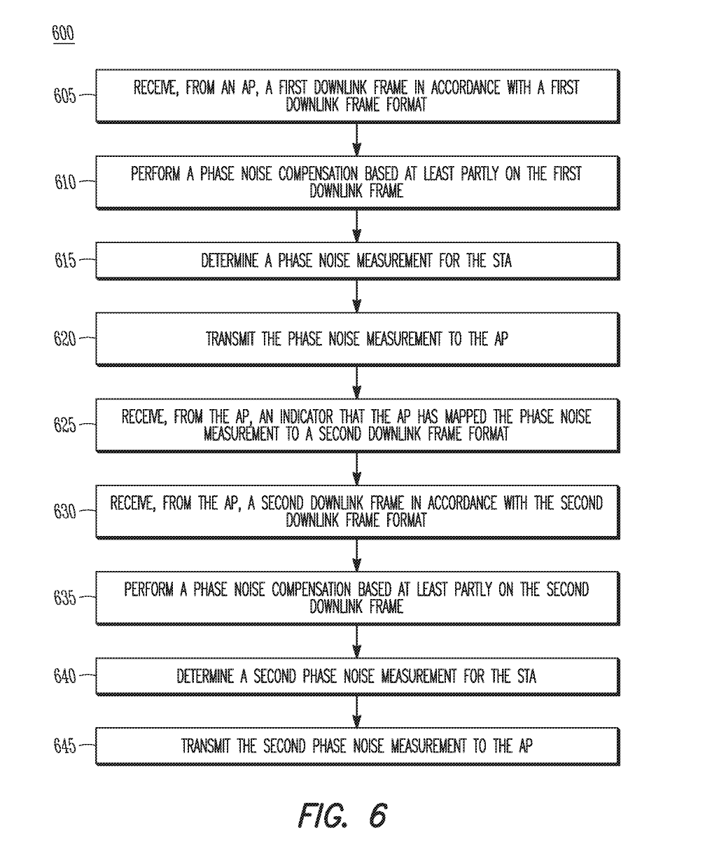

FIG. 6 illustrates the operation of another method of communication in accordance with some embodiments. As mentioned previously regarding the method 400, embodiments of the method 600 may include additional or even fewer operations or processes in comparison to what is illustrated in FIG. 6 and embodiments of the method 600 are not necessarily limited to the chronological order that is shown in FIG. 6. In describing the method 600, reference may be made to FIGS. 1-5 and 7, although it is understood that the method 600 may be practiced with any other suitable systems, interfaces and components. In addition, embodiments of the method 600 may be applicable to APs 102, STAs 103, UEs, eNBs or other wireless or mobile devices. The method 600 may also refer to an apparatus for an AP 102, STA 103 and/or other device described above.

It should be noted that the method 600 may be practiced at an STA 103 and may include exchanging of frames, signals and/or messages with an AP 102. Similarly, the method 400 may be practiced at an AP 102 and may include exchanging of frames, signals and/or messages with an STA 103. In some cases, operations and techniques described as part of the method 400 may be relevant to the method 600. In addition, embodiments of the method 600 may include operations performed at the STA 103 that are reciprocal or similar to other operations described herein performed at the AP 102. For instance, an operation of the method 600 may include reception of a frame from the AP 102 by the STA 103 while an operation of the method 400 may include transmission of the same frame or similar frame by the AP 102.

In addition, previous discussion of various techniques and concepts may be applicable to the method 600 in some cases, including phase noise measurements, phase noise compensation, phase noise tracking, downlink frame formats, candidate downlink frame formats, selection from a group of candidate downlink frame formats, pilot symbols, pilot portions, data symbols, data portions, SC-FDM, OFDM, and others. In addition, the example downlink frame formats shown in FIG. 5 may also be applicable, in some cases, although the scope of embodiments is not limited in this respect.

At operation 605, the STA 103 may receive, from the AP 102, a first downlink frame in accordance with a first downlink frame format. As an example, the first downlink frame format may be based on a first ratio of pilot symbols to data symbols. As another example, the first downlink frame format may be based on a first number of pilot symbols and/or a first density of pilot symbols. In some embodiments, the STA 103 may decode a first downlink frame from the AP 102.

In some cases, the first downlink frame format may have been selected, by the AP 102, based at least partly on a phase noise measurement of the STA 103 communicated by the STA 103 to the AP 102. In some cases, the first downlink frame format may have been selected, by the AP 102, based at least partly on a default downlink frame format that may be used in cases such as when the STA 103 begins a communication session with the AP 102, when a hand-off to a new AP 102 occurs and/or other scenarios.

At operation 610, the STA 103 may perform a phase noise compensation. In some embodiments, phase noise tracking may be performed by the STA 103. At operation 615, the STA 103 may determine a phase noise measurement, and may communicate the measurement to the AP 102 at operation 620. In some embodiments, the STA 103 may generate an indicator of the phase noise measurement for transmission to the AP 102. It should be noted that operations 610 and 615 may be performed jointly in some cases, although embodiments are not limited as such. In some embodiments, the STA 103 may know and/or may be able to determine pilot symbol locations and values in accordance with the particular downlink frame format being used. Accordingly, the phase noise compensation, phase noise tracking and/or the phase noise measurement may be performed using the received pilot symbols of a received downlink frame, in some embodiments.

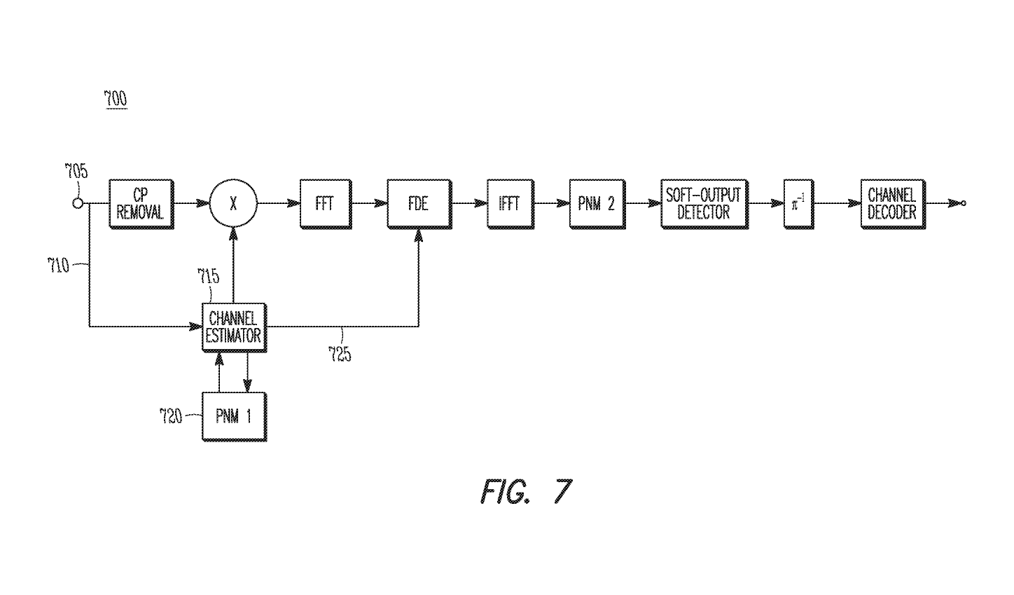

FIG. 7 illustrates an example block diagram of receiver operations in accordance with some embodiments. It should be noted that embodiments are not limited to these operations, as other techniques may be used for channel estimation, phase noise compensation, phase noise tracking, data detection and/or other operations. As shown in FIG. 7, an input signal 705 may be sent as an input 710 to a channel estimation block 715, which may operate jointly with a phase noise compensation/tracking block 720. The output signal 725 may have a reduced level of phase noise in comparison to the signals 705, 710, in some cases. It should be noted that any suitable techniques for channel estimation 710 and/or phase noise compensation/tracking 720 may be used in accordance with the downlink frame format of the signals 705, 710. In addition, a phase noise measurement may also be determined, using any suitable technique. As a non-limiting example, the phase noise measurement may be determined as part of the phase noise compensation/tracking 720 in FIG. 7, in some cases.

Returning to the method 600, at operation 625, the STA 103 may receive an indicator that the AP 102 has mapped the phase noise measurement to a second downlink frame format, which may be based on a second ratio of pilot symbols to data symbols. In some embodiments, the STA 103 may determine, based on an indicator from the AP 102, that the AP 102 has mapped the phase noise measurement to the second downlink frame format. In some cases, the AP 102 may include such an indicator in a header of a downlink frame and/or in a control message and/or control field, although embodiments are not limited as such. In some embodiments, the AP 102 may not necessarily signal the fact that the phase noise measurement was mapped to the second downlink frame format, but may indicate that the second downlink frame format is to be used, such as in a header, control message and/or control field.

As previously described, the AP 102 may select the second downlink frame format based at least partly on a phase noise measurement of the STA 103 that is communicated to the AP 102 by the STA 103. As an example, the AP 102 may determine that more pilots are to be used in the second downlink frame format in comparison to the first downlink frame format in order to improve phase noise compensation/tracking at the STA 103. As another example, the AP 102 may determine that fewer pilots are to be used in the second downlink frame format in comparison to the first downlink frame format in order to improve a downlink throughput. As another example, the AP 102 may determine that no change in downlink frame format is to occur, in which case the second downlink frame format may be the same as the first downlink frame format.

At operation 630, the STA 103 may receive, from the AP 102, a second downlink frame in accordance with the second downlink frame format. In some embodiments, the STA 103 may decode, in accordance with the second downlink frame format, a second downlink frame from the AP 102. At operation 635, the STA 103 may perform a phase noise compensation based at least partly on the second downlink frame. In some embodiments, the STA 103 may perform phase noise tracking based at least partly on the second downlink frame. At operation 640, the STA 103 may determine a second phase noise measurement for the STA 103. At operation 645, the second phase noise measurement may be transmitted to the AP 102. It should be noted that in some cases, pilot locations and/or values of the second downlink frame format may be different from those of the first downlink frame format, which may be taken into account for the phase noise compensation, phase noise tracking and/or phase noise measurement operations. In addition, as previously described regarding the method 400, one or more operations of the method 600, such as the determination and/or communication of phase noise measurements, may be performed subsequently in a manner that may enable the AP 102 and STA 103 to continue to monitor whether or not to use a different downlink frame format based on phase noise measurements,

In some cases, a phase noise level may be relatively high. For instance, a device operating in mmWave frequency bands may experience a relatively high phase noise. In such cases, a performance benefit may be realized through usage of a larger number of pilots than what may typically be used for device operation in other frequency bands. Accordingly, in some embodiments, a base station (such as an AP 102, eNB and/or other) may allocate a variable number of pilots (and/or ratio of pilots to data) in one or more frames/blocks/signals as part of communication with one or more mobile devices. In some cases, such a variation in the number of pilots used for different mobile devices (and/or in different frames) may enable a suitable level of phase noise estimation, tracking and/or compensation for individual mobile devices. For instance, a first mobile device operating with a relatively high phase noise level may be allocated, by the base station, a larger number of pilots than a second mobile device operating with a lower phase noise level. The base station may allocate the variable number of pilots to different mobile devices based at least partly on feedback from those mobile devices. It should be noted that such differences in phase noise level (and/or other impairment levels) of the mobile devices may be based on a number of factors, including but not limited to temperature, device cost, device age, frequency band of operation and/or other factors. In some embodiments, positions of transmitted pilots within each symbol/block/frame may be variable for one or more of the mobile devices. Such variation of the positions may be configured, by the base station, based at least partly on feedback from the mobile devices, in some cases. It should also be noted that the number and/or position of the pilots may be configured for the mobile devices by the base station based at least partly on a device category, device type and/or other similar factors, in some embodiments.

In some cases, a number of pilot symbols, a density of pilot symbols and/or ratio of pilot symbols to data symbols may be relatively high, which may negatively affect an over the air throughput. It may be determined, in some cases, that a level of phase noise has little or no effect on the system performance. Accordingly, a different frame with a lower number of pilot symbols, a density of pilot symbols and/or ratio of pilot symbols to data symbols may be used instead, which may increase throughput in some cases.

In Example 1, an apparatus for an access point (AP) may comprise memory and processing circuitry configured to determine, based on a message from a station (STA), a phase noise measurement of the STA. The processing circuitry may be further configured to select, based at least partly on the phase noise measurement, a downlink frame format to enable a phase noise compensation at the STA. The processing circuitry may be further configured to generate, for transmission to the STA, a downlink frame in accordance with the selected downlink frame format. The downlink frame format may be selected from a group of candidate downlink frame formats that are based on data portions and pilot portions, and sizes of the pilot portions of at least some of the candidate downlink frame formats may be different.

In Example 2, the subject matter of Example 1, wherein the downlink frame may include a single carrier frequency division multiplexing (SC-FDM) signal. The data portions and the pilot portions of the candidate downlink frame formats may be multiplexed in time resources of the candidate downlink frame formats.

In Example 3, the subject matter of one or any combination of Examples 1-2, wherein the time resources for a first candidate downlink frame format in the group may be allocated for a first pilot portion of a first pilot size followed by a first data portion of a first data size. The time resources for a second candidate downlink frame format in the group may be allocated for a second pilot portion of a second pilot size followed by a second data portion of a second data size. A first combined size of the first pilot portion and the first data portion may be equal to a first combined size of the second pilot portion and the second data portion. The first pilot size may be lower than the second pilot size. The first candidate downlink frame format may be selected when the phase noise measurement is in a first range and the second candidate downlink frame format may be selected when the phase noise measurement is in a second range that is higher than the first range.

In Example 4, the subject matter of one or any combination of Examples 1-3, wherein the time resources for a third candidate downlink frame format in the group may be allocated for a payload portion that includes a third data portion and excludes pilot portions. A size of the payload portion of the third candidate downlink frame format may be equal to the first combined size. The third candidate downlink frame format may be selected when the phase noise measurement is in a third range that is lower than the first range.

In Example 5, the subject matter of one or any combination of Examples 1-4, wherein the time resources for a first candidate downlink frame format in the group may be allocated for a first pilot portion of a first pilot size and a first data portion of a first data size. The first pilot portion may include multiple sub-portions that are interleaved with multiple sub-portions of the first data portion. The time resources for a second candidate downlink frame format in the group may be allocated for a second pilot portion of a second pilot size and a second data portion of a second data size. The second pilot portion may include multiple sub-portions that are interleaved with multiple sub-portions of the second data portion. A first combined size of the first pilot portion and the first data portion may be equal to a first combined size of the second pilot portion and the second data portion. The first pilot size may be lower than the second pilot size. The first candidate downlink frame format may be selected when the phase noise measurement is in a first range and the second candidate downlink frame format may be selected when the phase noise measurement is in a second range that is higher than the first range.

In Example 6, the subject matter of one or any combination of Examples 1-5, wherein the downlink frame may include an orthogonal frequency division multiplexing (OFDM) signal. The data portions and the pilot portions of the candidate downlink frame formats may be multiplexed in frequency resources of the candidate downlink frame formats.

In Example 7, the subject matter of one or any combination of Examples 1-6, wherein the selection of the downlink frame format may be based on a mapping between the candidate downlink frame formats and phase noise ranges for the phase noise measurement.

In Example 8, the subject matter of one or any combination of Examples 1-7, wherein the mapping may be based at least partly on a non-decreasing relationship between the phase noise ranges and the sizes of the pilot portions of the candidate downlink frame formats.

In Example 9, the subject matter of one or any combination of Examples 1-8, wherein for at least some of the candidate downlink frame formats, ratios between the sizes of the pilot portions and sizes of the data portions may be different.

In Example 10, the subject matter of one or any combination of Examples 1-9, wherein the downlink frame format may be a second downlink frame format and the downlink frame may be a second downlink frame. The processing circuitry may be further configured to generate, for transmission to the STA, a first downlink frame in accordance with a first downlink frame format. The first downlink frame format may be included in the group of candidate downlink frame formats. The transmission of the first downlink frame may be prior to the transmission of the second downlink frame.

In Example 11, the subject matter of one or any combination of Examples 1-10, wherein the sizes of the pilot portions of the first and second downlink frame formats may be different.

In Example 12, the subject matter of one or any combination of Examples 1-11, wherein the phase noise measurement may be based at least partly on a comparison between oscillator power levels of the STA at an oscillator frequency of the STA and an offset frequency with respect to the oscillator frequency.

In Example 13, the subject matter of one or any combination of Examples 1-12, wherein the apparatus may further include a transceiver to transmit the downlink frame. The transceiver may be configured to operate in a millimeter wave (mmWave) frequency range to transmit the downlink frame.

In Example 14, the subject matter of one or any combination of Examples 1-13, wherein the AP may be arranged to operate in accordance with a wireless local area network (WLAN) protocol.

In Example 15, the subject matter of one or any combination of Examples 1-14, wherein the processing circuitry may include a baseband processor to select the downlink frame format.

In Example 16, a non-transitory computer-readable storage medium may store instructions for execution by one or more processors to perform operations for communication by a base station. The operations may configure the one or more processors to select, based on a phase noise measurement of a first mobile device, a first downlink frame format from a group of candidate downlink frame formats. The operations may further configure the one or more processors to select, based on a phase noise measurement of a second mobile device, a second downlink frame format from the group. The operations may configure the one or more processors to generate, for transmission to the first mobile device, a first downlink frame in accordance with the first downlink frame format. The operations may configure the one or more processors to generate, for transmission to the second mobile device, a second downlink frame in accordance with the second downlink frame format. A first ratio of pilot symbols to data symbols of the first downlink frame format may be different from a second ratio of pilot symbols to data symbols of the second downlink frame format.

In Example 17, the subject matter of Example 16, wherein the first downlink frame may include a first single carrier frequency division multiplexing (SC-FDM) signal and the second downlink frame may include a second SC-FDM signal. The data symbols and the pilot symbols of the first downlink frame format may be multiplexed in time resources of the first downlink frame format. The data symbols and the pilot symbols of the second downlink frame format may be multiplexed in time resources of the second downlink frame format.

In Example 18, the subject matter of one or any combination of Examples 16-17, wherein the selections of the downlink frame formats may be based on a mapping between the candidate downlink frame formats and phase noise ranges for the phase noise measurements. The mapping may be based at least partly on a non-decreasing relationship between the phase noise ranges and ratios of pilot symbols to data symbols in the candidate downlink frame formats.

In Example 19, the subject matter of one or any combination of Examples 16-18, wherein the base station may include an access point (AP) that is arranged to operate in accordance with a wireless local area network (WLAN) protocol.

In Example 20, the subject matter of one or any combination of Examples 16-19, wherein the base station may include an Evolved Node-B (eNB) that is arranged to operate in accordance with a Third Generation Partnership Project (3GPP) Long Term Evolution (LTE) protocol.

In Example 21, an apparatus for a station (STA) may comprise memory and processing circuitry configured to decode, in accordance with a first downlink frame format based on a first ratio of pilot symbols to data symbols, a first downlink frame from an access point (AP). The processing circuitry may be further configured to generate, for transmission to the AP, an indicator of a phase noise measurement of the STA. The processing circuitry may be further configured to determine, based on an indicator from the AP, that the AP has mapped the phase noise measurement to a second downlink frame format. The second downlink frame format may be based on a second ratio of pilot symbols to data symbols. The processing circuitry may be further configured to decode, in accordance with the second downlink frame format, a second downlink frame from the AP. The first and second downlink frame formats may be included in a group of candidate downlink frame formats.

In Example 22, the subject matter of Example 21, wherein the first downlink frame may include a first single carrier frequency division multiplexing (SC-FDM) signal and the second downlink frame may include a second SC-FDM signal. Data portions and pilot portions of the candidate downlink frame formats may be multiplexed in time resources of the candidate downlink frame formats.

In Example 23, the subject matter of one or any combination of Examples 21-22, wherein the first downlink frame may be based on a first block of payload symbols that includes a first group of one or more contiguous blocks of pilot symbols and further includes a first group of one or more contiguous blocks of data symbols. The second downlink frame may be based on a second block of payload symbols that includes a second group of one or more contiguous blocks of pilot symbols and further includes a second group of one or more contiguous blocks of data symbols. A first combined size of the first group of pilot symbols and the first group of data symbols may be equal to a second combined size of the second group of pilot symbols and the second group of data symbols. A first pilot size of the first group of pilot symbols may be different from a second pilot size of the second group of pilot symbols.

In Example 24, the subject matter of one or any combination of Examples 21-23, wherein the first downlink frame may include a first orthogonal frequency division multiplexing (OFDM) signal and the second downlink frame may include a second OFDM signal. Data portions and pilot portions of the candidate downlink frame formats may be multiplexed in frequency resources of the candidate downlink frame formats.

In Example 25, the subject matter of one or any combination of Examples 21-24, wherein the indicator of the phase noise measurement may be generated for transmission to the AP to enable the STA to decode one or more downlink frames from the AP with an increased or decreased ratio of pilot symbols to data symbols in comparison to the first ratio of pilot symbols to data symbols.

In Example 26, the subject matter of one or any combination of Examples 21-25, wherein the phase noise measurement may be based at least partly on a comparison between oscillator power levels of the STA at an oscillator frequency of the STA and an offset frequency with respect to the oscillator frequency.

In Example 27, the subject matter of one or any combination of Examples 21-26, wherein the second downlink frame may be decoded in accordance with a phase noise compensation of an oscillator phase noise. The oscillator phase noise may be tracked for the phase noise compensation based at least partly on pilot symbols in the second downlink frame.

In Example 28, a method of communication at an access point (AP) may comprise determining, based on a message from a station (STA), a phase noise measurement of the STA. The method may further comprise selecting, based at least partly on the phase noise measurement, a downlink frame format to enable a phase noise compensation at the STA. The method may further comprise generating, for transmission to the STA, a downlink frame in accordance with the selected downlink frame format. The downlink frame format may be selected from a group of candidate downlink frame formats that are based on data portions and pilot portions, and sizes of the pilot portions of at least some of the candidate downlink frame formats may be different.

In Example 29, the subject matter of Example 28, wherein the selection of the downlink frame format may be based on a mapping between the candidate downlink frame formats and phase noise ranges for the phase noise measurement. The mapping may be based at least partly on a non-decreasing relationship between the phase noise ranges and the sizes of the pilot portions of the candidate downlink frame formats.

In Example 30, an access point (AP), comprises: means for determining, based on a message from a station (STA), a phase noise measurement of the STA; means for selecting, based at least partly on the phase noise measurement, a downlink frame format to enable a phase noise tracking at the STA; and means for generating, for transmission to the STA, a downlink frame in accordance with the selected downlink frame format, wherein the downlink frame format is selected from a group of candidate downlink frame formats that are based on data portions and pilot portions, and sizes of the pilot portions of at least some of the candidate downlink frame formats are different.

In Example 31, the subject matter of Example 30, wherein the means for selecting the downlink frame format is based on a mapping between the candidate downlink frame formats and phase noise ranges for the phase noise measurement, and the mapping is based at least partly on a non-decreasing relationship between the phase noise ranges and the sizes of the pilot portions of the candidate downlink frame formats.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus for an access point (AP), the apparatus comprising memory and processing circuitry configured to:
determine, based on a message from a station (STA), a phase noise measurement of the STA;
select, based at least partly on the phase noise measurement, a downlink frame format to enable a phase noise compensation at the STA; and
generate, for transmission to the STA, a downlink frame in accordance with the selected downlink frame format,
wherein the downlink frame format is selected from a group of candidate downlink frame formats that are based on data portions and pilot portions, and sizes of the pilot portions of at least some of the candidate downlink frame formats are different.

2. The apparatus according to claim 1, wherein:
the downlink frame includes a single carrier frequency division multiplexing (SC-FDM) signal,
the data portions and the pilot portions of the candidate downlink frame formats are multiplexed in time resources of the candidate downlink frame formats.

3. The apparatus according to claim 2, wherein:
the time resources for a first candidate downlink frame format in the group are allocated for a first pilot portion of a first pilot size followed by a first data portion of a first data size,
the time resources for a second candidate downlink frame format in the group are allocated for a second pilot portion of a second pilot size followed by a second data portion of a second data size,
a first combined size of the first pilot portion and the first data portion is equal to a first combined size of the second pilot portion and the second data portion,
the first pilot size is lower than the second pilot size, and
the first candidate downlink frame format is selected when the phase noise measurement is in a first range and the second candidate downlink frame format is selected when the phase noise measurement is in a second range that is higher than the first range.

4. The apparatus according to claim 3, wherein:
the time resources for a third candidate downlink frame format in the group are allocated for a payload portion that includes a third data portion and excludes pilot portions,
a size of the payload portion of the third candidate downlink frame format is equal to the first combined size, and
the third candidate downlink frame format is selected when the phase noise measurement is in a third range that is lower than the first range.

5. The apparatus according to claim 2, wherein:
the time resources for a first candidate downlink frame format in the group are allocated for a first pilot portion of a first pilot size and a first data portion of a first data size, wherein the first pilot portion includes multiple sub-portions that are interleaved with multiple sub-portions of the first data portion,
the time resources for a second candidate downlink frame format in the group are allocated for a second pilot portion of a second pilot size and a second data portion of a second data size, wherein the second pilot portion includes multiple sub-portions that are interleaved with multiple sub-portions of the second data portion,
a first combined size of the first pilot portion and the first data portion is equal to a first combined size of the second pilot portion and the second data portion,
the first pilot size is lower than the second pilot size, and
the first candidate downlink frame format is selected when the phase noise measurement is in a first range and the second candidate downlink frame format is selected when the phase noise measurement is in a second range that is higher than the first range.

6. The apparatus according to claim 1, wherein:
the downlink frame includes an orthogonal frequency division multiplexing (OFDM) signal,
the data portions and the pilot portions of the candidate downlink frame formats are multiplexed in frequency resources of the candidate downlink frame formats.

7. The apparatus according to claim 1, wherein the selection of the downlink frame format is based on a mapping between the candidate downlink frame formats and phase noise ranges for the phase noise measurement.

8. The apparatus according to claim 7, wherein the mapping is based at least partly on a non-decreasing relationship between the phase noise ranges and the sizes of the pilot portions of the candidate downlink frame formats.

9. The apparatus according to claim 1, wherein for at least some of the candidate downlink frame formats, ratios between the sizes of the pilot portions and sizes of the data portions are different.

10. The apparatus according to claim 1, wherein:
the downlink frame format is a second downlink frame format and the downlink frame is a second downlink frame,
the processing circuitry is further configured to generate, for transmission to the STA, a first downlink frame in accordance with a first downlink frame format,
the first downlink frame format is included in the group of candidate downlink frame formats, and
the transmission of the first downlink frame is prior to the transmission of the second downlink frame.

11. The apparatus according to claim 10, wherein the sizes of the pilot portions of the first and second downlink frame formats are different.

12. The apparatus according to claim 1, wherein the phase noise measurement is based at least partly on a comparison between oscillator power levels of the STA at an oscillator frequency of the STA and an offset frequency with respect to the oscillator frequency.

13. The apparatus according to claim 1, wherein:
the apparatus further includes a transceiver to transmit the downlink frame, and
the transceiver is configured to operate in a millimeter way (mmWave) frequency range to transmit the downlink frame.

14. The apparatus according to claim 1, wherein the AP is arranged to operate in accordance with a wireless local area network (WLAN) protocol.

15. The apparatus according to claim 1, wherein the processing circuitry includes a baseband processor to select the downlink frame format.

16. A non-transitory computer-readable storage medium that stores instructions for execution by one or more processors to perform operations for communication by a base station, the operations to configure the one or more processors to:
select, based on a phase noise measurement of a first mobile device, a first downlink frame format from a group of candidate downlink frame formats;
select, based on a phase noise measurement of a second mobile device, a second downlink frame format from the group;
generate, for transmission to the first mobile device, a first downlink frame in accordance with the first downlink frame format; and
generate, for transmission to the second mobile device, a second downlink frame in accordance with the second downlink frame format;
wherein a first ratio of pilot symbols to data symbols of the first downlink frame format is different from a second ratio of pilot symbols to data symbols of the second downlink frame format.

17. The non-transitory computer-readable storage medium according to claim 16, wherein:
the first downlink frame includes a first single carrier frequency division multiplexing (SC-FDM) signal and the second downlink frame includes a second SC-FDM signal,
the data symbols and the pilot symbols of the first downlink frame format are multiplexed in time resources of the first downlink frame format, and
the data symbols and the pilot symbols of the second downlink frame format are multiplexed in time resources of the second downlink frame format.

18. The non-transitory computer-readable storage medium according to claim 16, wherein:
the selections of the downlink frame formats are based on a mapping between the candidate downlink frame formats and phase noise ranges for the phase noise measurements, and
the mapping is based at least partly on a non-decreasing relationship between the phase noise ranges and ratios of pilot symbols to data symbols in the candidate downlink frame formats.

19. The non-transitory computer-readable storage medium according to claim 16, wherein the base station includes an access point (AP) that is arranged to operate in accordance with a wireless local area network (WLAN) protocol.

20. The non-transitory computer-readable storage medium according to claim 16, wherein the base station includes an Evolved Node-B (eNB) that is arranged to operate in accordance with a Third Generation Partnership Project (3GPP) Long Term Evolution (LTE) protocol.

21. An apparatus for a station (STA), the apparatus comprising memory and processing circuitry configured to:
decode, in accordance with a first downlink frame format based on a first ratio of pilot symbols to data symbols, a first downlink frame from an access point (AP);
generate, for transmission to the AP, an indicator of a phase noise measurement of the STA;
determine, based on an indicator from the AP, that the AP has mapped the phase noise measurement to a second downlink frame format, wherein the second downlink frame format is based on a second ratio of pilot symbols to data symbols; and
decode, in accordance with the second downlink frame format, a second downlink frame from the AP,
wherein the first and second downlink frame formats are included in a group of candidate downlink frame formats.

22. The apparatus according to claim 21, wherein:
the first downlink frame includes a first single carrier frequency division multiplexing (SC-FDM) signal and the second downlink frame includes a second SC-FDM signal, and
data portions and pilot portions of the candidate downlink frame formats are multiplexed in time resources of the candidate downlink frame formats.

23. The apparatus according to claim 22, wherein:
the first downlink frame is based on a first block of payload symbols that includes a first group of one or more contiguous blocks of pilot symbols and further includes a first group of one or more contiguous blocks of data symbols,
the second downlink frame is based on a second block of payload symbols that includes a second group of one or more contiguous blocks of pilot symbols and further includes a second group of one or more contiguous blocks of data symbols,
a first combined size of the first group of pilot symbols and the first group of data symbols is equal to a second combined size of the second group of pilot symbols and the second group of data symbols,
a first pilot size of the first group of pilot symbols is different from a second pilot size of the second group of pilot symbols.

24. The apparatus according to claim 21, wherein:
the first downlink frame includes a first orthogonal frequency division multiplexing (OFDM) signal and the second downlink frame includes a second OFDM signal, and
data portions and pilot portions of the candidate downlink frame formats are multiplexed in frequency resources of the candidate downlink frame formats.

25. The apparatus according to claim 21, wherein the indicator of the phase noise measurement is generated for transmission to the AP to enable the STA to decode one or more downlink frames from the AP with an increased or decreased ratio of pilot symbols to data symbols in comparison to the first ratio of pilot symbols to data symbols.

26. The apparatus according to claim 21, wherein the phase noise measurement is based at least partly on a comparison between oscillator power levels of the STA at an oscillator frequency of the STA and an offset frequency with respect to the oscillator frequency.

27. The apparatus according to claim 21, wherein:
the second downlink frame is decoded in accordance with a phase noise compensation of an oscillator phase noise, and
the oscillator phase noise is tracked for the phase noise compensation based at least partly on pilot symbols in the second downlink frame.

28. A method of communication at an access point (AP), the method comprising:
determining, based on a message from a station (STA), a phase noise measurement of the STA;
selecting, based at least partly on the phase noise measurement, a downlink frame format to enable a phase noise tracking at the STA; and
generating, for transmission to the STA, a downlink frame in accordance with the selected downlink frame format,
wherein the downlink frame format is selected from a group of candidate downlink frame formats that are based on data portions and pilot portions, and sizes of the pilot portions of at least some of the candidate downlink frame formats are different.

29. The method according to claim 28, wherein:
the selection of the downlink frame format is based on a mapping between the candidate downlink frame formats and phase noise ranges for the phase noise measurement, and
the mapping is based at least partly on a non-decreasing relationship between the phase noise ranges and the sizes of the pilot portions of the candidate downlink frame formats.
